(19) United States
(12) Patent Application Publication
(10) Pub. No.: US 2012/0281901 A1
(43) Pub. Date: Nov. 8, 2012

(54) MAGNETIC RESONANCE IMAGING APPARATUS AND BLOOD VESSEL IMAGE CAPTURING METHOD

(76) Inventors: Nobuyuki Yoshizawa, Tokyo (JP); Hiroyuki Itagaki, Tokyo (JP)

(21) Appl. No.: 13/520,400

(22) PCT Filed: Jan. 20, 2011
(86) PCT No.: PCT/JP2011/050913

§ 371 Date: Jul. 3, 2012

(30) Foreign Application Priority Data
Jan. 22, 2010 (JP) 2010-011733

(51) Int. Cl. G06K 9/36

(52) U.S. Cl. 382/131; 382/134

(57) ABSTRACT

In order to acquire a non-contrast MRA image in which blurring of the blood vessel is suppressed to improve the visualization ability even if there is an influence of T2 attenuation in echo data, the imaging sequence for measuring the echo data along the measurement trajectories non-parallel to two directions perpendicular to the readout direction in the three-dimensional K space is executed in synchronization with the periodic body motion information of an object. In this case, the repetition time (TR) of the imaging sequence is set to be a plurality of periods of the periodic body motion information.

### TECHNICAL FIELD

The present invention relates to a technique for improving the quality of an acquired blood vessel image by performing imaging in synchronization with body motion information of an object in magnetic resonance imaging (hereinafter, referred to as an “MRI”).

### BACKGROUND ART

The MRI apparatus is a measuring apparatus which acquires an image of an object using a nuclear magnetic resonance (NMR) phenomenon. The MRI apparatus irradiates the object with a high-frequency magnetic field (hereinafter, referred to as an “RF”) pulse and measures an NMR signal, which is generated by nuclear spins which form tissue of the object, as the response. Then, on the basis of the measured NMR signal, the shapes or functions of the head, abdomen, limbs, and the like of the object are imaged in a two-dimensional or three-dimensional manner. In the imaging, different phase encoding or different slice encoding is given to NMR signals by the gradient magnetic field and frequency encoding is also given to the NMR signals, and the NMR signals are measured as time-series data. The measured NMR signals are reconstructed as an image by a two-dimensional or three-dimensional Fourier transform.

Using the MRI apparatus, a blood vessel image (MRA image) of the object is acquired in a non-contrast manner, that is, without administering the contrast medium to the object.

As one of the methods, as disclosed in PTL 1, there is a method in which an operation to collect echo signals equivalent to a predetermined amount of slice encoding by the fast spin echo (FSE) sequence is repeated every plural cardiac beats in synchronization with a signal, which indicates the cardiac phase of an object collected by time phase detection means, after delay time (DT) set by the signal. For example, if the delay time is set in systole to collect echo signals, a vein image in which the vein is mainly visualized is obtained. If the delay time is set in diastole, an arteriovenous image in which both the artery and the vein are visualized is obtained. In addition, by the difference of these two image data items, an artery image in which the artery is mainly visualized is obtained.

Moreover, in PTL 2, in order to improve the ability to visualize blood vessels that travel in the phase encoding direction, a dephase gradient magnetic field pulse or a rephase gradient magnetic field pulse is applied in the phase encoding direction. It is also possible to apply the dephase gradient magnetic field pulse or the rephase gradient magnetic field pulse in the readout direction. In this case, the ability to visualize blood vessels that travel in the readout direction is improved. In addition, it is also possible to apply the dephase gradient magnetic field pulse or the rephase gradient magnetic field pulse in both the readout direction and the phase encoding direction.

### CITATION LIST

### Patent Literature

[PTL 1] Japanese Patent No. 4090619
[PTL 2] Japanese Patent No. 4309632
[PTL 3] JP-A-7-284485

### Non Patent Literature

[NPL 1] J. I. Jackson et. al., Selection of a Convolution Function for Fourier Inversion Using Gridding, IEEE Trans. Med. Imaging, vol. 10, PP. 473-478, 1991

### SUMMARY OF INVENTION

### Technical Problem that the Invention is to Solve

In PTL 1 echo data having an influence of T2 attenuation in either the phase encoding direction or the slice encoding direction is acquired, and a non-contrast MRA image is acquired by imaging the echo data by the Fourier transform. For this reason, if imaging of the echo data having an influence of T2 attenuation in either one direction is performed, the image becomes a non-contrast MRA image which blurs in the phase encoding direction or the slice encoding direction. This may have an adverse effect on diagnosis.

Moreover, in PTL 2, the ability to visualize blood vessels that travel in the slice encoding direction is not taken into consideration since a dephase gradient magnetic field pulse or a rephase gradient magnetic field pulse is not applied in the slice encoding direction.

Therefore, it is an object of the present invention to acquire a non-contrast MRA image, in which blurring of the blood vessel is suppressed to improve the visualization ability, even if there is an influence of T2 attenuation in echo data.

### Solution to Problem

In order to achieve the above-described object, in the present invention, the imaging sequence for measuring the echo data along the measurement trajectories non-parallel to two directions perpendicular to the readout direction in the three-dimensional K space is executed in synchronization with the periodic body motion information of an object. In this case, the repetition time (TR) of the imaging sequence is set to be a plurality of periods of the periodic body motion information.

Specifically, an MRI apparatus of the present invention includes a body motion information detection unit that detects body motion information regarding periodic body motion of an object, a measurement control unit that controls measurement of three-dimensional K space data by executing synchronous imaging synchronized with the periodic body motion information on the basis of an imaging sequence, and an arithmetic processing unit that reconstructs a blood vessel image of the object using the three-dimensional K space data, and is characterized in that the imaging sequence is for measuring echo data along measurement trajectories non-parallel to two directions perpendicular to a readout direction in the three-dimensional K space and the measurement control unit controls the synchronous imaging such that a repetition time (TR) of the imaging sequence becomes a plurality of periods of the body motion information.

Preferably, the measurement trajectories are a plurality of linear measurement trajectories obtained by rotating one linear trajectory with the readout direction of the three-dimensional K space as a rotation axis, and the measurement control unit repeats the imaging sequence to measure echo data along different linear trajectories.

In addition, a blood vessel image capturing method of the present invention includes a measurement step of measuring echo data along predetermined measurement trajectories in a three-dimensional K space by synchronous imaging in which an imaging sequence is synchronized with an electrocardiogram of an object, and a step of acquiring a blood vessel image of the object using the measured echo data, and is characterized in that the measurement trajectories are measurement trajectories non-parallel to two directions perpendicular to a readout direction in the three-dimensional K space and a repetition time (TR) of the imaging sequence is a plurality of periods of the electrocardiogram.

### Advantageous Effects of Invention

According to the MRI apparatus and the blood vessel image capturing method of the present invention, even if there is an influence of T2 attenuation in echo data, it is possible to acquire a non-contrast MRA image in which blurring of the blood vessel is suppressed to improve the visualization ability. In particular, it is possible to acquire a non-contrast MRA image with the improved ability to visualize blood vessels that travel in directions (for example, when the readout direction is H-F (Head-Foot), R-L (Right-Left) and A-P (Anterior-Posterior)) other than the readout direction.

### BRIEF DESCRIPTION OF DRAWINGS

FIG. 1 is a block diagram showing the entire configuration of an example of an MRI apparatus related to the present invention.

FIG. 2 is a view showing measurement trajectories for performing Non-Cartesian sampling of the (k1-k2) space in a first embodiment.

FIG. 3 is a sequence chart showing the imaging sequence for measuring the echo data along the measurement trajectory shown in FIG. 2 in the first embodiment.

FIG. 4 is a flow chart showing the operation flow of the first embodiment.

FIG. 5 is a sequence chart showing an example of a PC (Phase Contrast) method pulse sequence, which is used as a reference scan, in the first embodiment.

FIG. 6 is a view showing an example of a blood flow change graph that shows the relationship between changes in the blood flow speed of the artery and the vein in the imaging region and the electrocardiogram.

FIG. 7 is a synchronous imaging synchronized with an electrocardiogram, and is a view showing an example where a plurality of cardiac beats (R-R) are set as a repetition time (TR) of the imaging sequence. FIG. 7(a) shows an example where delay time (DT) is set in systole to acquire a vein image, and FIG. 7(b) shows an example where the delay time (DT) is set in diastole to acquire an arteriovenous image.

FIG. 8 is a sequence chart showing the imaging sequence of a second embodiment, and the sequence chart is obtained by adding a dephase gradient magnetic field pulse or a rephase gradient magnetic field pulse to the imaging sequence of the first embodiment shown in FIG. 3 in the three directions.

FIG. 9 is a view showing measurement trajectories for performing Non-Cartesian sampling of the (k1-k2) space in a third embodiment.

FIG. 10 is a sequence chart showing the imaging sequence for measuring the echo data along the measurement trajectory shown in FIG. 9 in the third embodiment.

FIG. 11 is a view showing measurement trajectories for performing Non-Cartesian sampling of the (k1-k2) space in a fourth embodiment.

FIG. 12 is a sequence chart showing the imaging sequence for measuring the echo data along the measurement trajectory shown in FIG. 9 in the fourth embodiment.

FIG. 13 is a view showing measurement trajectories for performing Non-Cartesian sampling of the (k1-k2) space in a fifth embodiment.

FIG. 14 is a sequence chart showing the imaging sequence for measuring the echo data along the measurement trajectory shown in FIG. 9 in a fifth embodiment.

FIG. 15 is a view showing one basic zigzag measurement trajectory for performing Non-Cartesian zigzag sampling of the echo data of the grid point of the (k1-k2) space in a sixth embodiment. FIG. 15(a) shows a basic zigzag measurement trajectory having a width in the k1 (k2) direction which is smaller than a basic zigzag measurement trajectory shown in FIG. 15(b).

FIG. 16 is a view showing a measurement trajectory for performing Non-Cartesian random sampling of the echo data of the grid point of the (k1-k2) space in the sixth embodiment.

### DESCRIPTION OF EMBODIMENTS

Hereinafter, preferred embodiments of an MDI apparatus of the present invention will be described in detail according to the accompanying drawings. In addition, in all drawings for explaining the embodiments of the present invention, the same reference numerals are given to those with the same functions and repeated explanation thereof will be omitted.

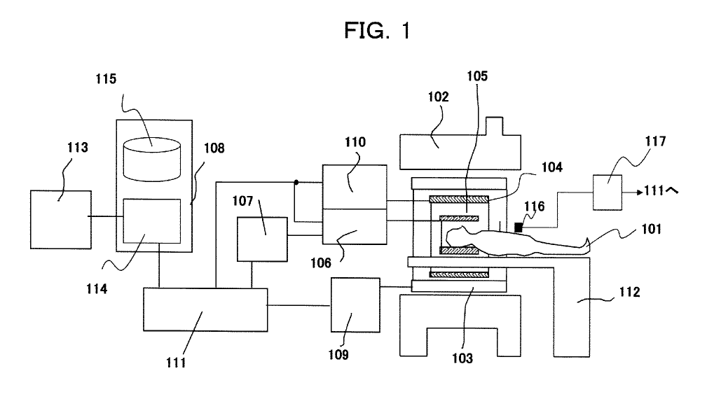

First, the outline of an example of an MRI apparatus related to the present invention will be described on the basis of FIG. 1. FIG. 1 is a block diagram showing the entire configuration of an example of the MRI apparatus related to the present invention. This MRI apparatus acquires a tomographic image of an object 101 using an NMR phenomenon. As shown in FIG. 1, the MRI apparatus is configured to include a static magnetic field generation magnet 102, a gradient magnetic field coil 103 and a gradient magnetic field power source 109, a transmission RF coil 104 and an RF transmission unit 110, a receiving RF coil 105 and a signal detection unit 106, a signal processing unit 107, a measurement control unit 111, an overall control unit 108, a display and operation unit 113, and a bed 112 on which the object 101 is carried and which takes the object 101 to the inside of the static magnetic field generation magnet 102.

The static magnetic field generation magnet 102 generates a uniform static magnetic field in a direction perpendicular to the body axis of the object 101 in the case of a vertical magnetic field method and in the body axis direction in the case of a horizontal magnetic field method. A permanent magnet type, a normal conducting type, or a superconducting type static magnetic field generator is disposed around the object 101.

The gradient magnetic field coil 103 is a coil wound in three axial directions of X, Y, and Z, which are the real space coordinate system (stationary coordinate system) of the MRI apparatus, and each gradient magnetic field coil is connected to the gradient magnetic field power source 109, which drives the gradient magnetic field coil, so that a current is supplied thereto. Specifically, the gradient magnetic field power source 109 of each gradient magnetic field coil is driven according to a command from the measurement control unit 111, which will be described later, and supplies a current to each gradient magnetic field coil. As a result, the gradient magnetic fields Gx, Gy, and Gz are generated in the three axial directions of X, Y, and Z, respectively.

At the time of imaging of the two-dimensional slice surface, a slice gradient magnetic field pulse (Gs) is applied in a direction perpendicular to the slice surface (cross section of imaging) so that a slice surface of the object 101 is set, and a phase encoding gradient magnetic field pulse (Gp) and a frequency encoding (readout) gradient magnetic field pulse (Gf) are applied in the two remaining directions, which are perpendicular to the slice surface and are also perpendicular to each other, so that the positional information in each direction is encoded in an echo signal. Control at the time of imaging of the three-dimensional region related to the present invention will be described later.

The transmission RF coil 104 is a coil which irradiates the object 101 with an RF pulse, and is connected to the RF transmission unit 110 so that a high-frequency pulse current supplied thereto. As a result, an NMR phenomenon is induced in nuclear spins of atoms which form body tissue of the object 101. Specifically, the RF transmission unit 110 is driven according to a command from the measurement control unit 111, which will be described later, to perform amplitude modulation of the high-frequency pulse. By supplying this amplified pulse to the transmission RF coil 104 disposed close to the object 101, the object 101 is irradiated with the RF pulse.

The receiving RF coil 105 is a coil which receives an NMR signal (echo signal) emitted by the NMR phenomenon of the nuclear spins which form body tissue of the object 101, and is connected to the signal detection unit 106 so that the received echo signal is transmitted to the signal detection unit 106. The signal detection unit 106 performs detection processing of the echo signal received by the receiving RF coil 105. Specifically, a response echo signal of the object 101 induced by the RF pulse irradiated from the RF transmission coil 104 is received in the receiving RF coil 105 disposed close to the object 101. The signal detection unit 106 amplifies the received echo signal according to the command from the measurement control unit 111 to be described later, divides the amplified signal into two signals perpendicular to each other by orthogonal phase detection, performs sampling of each signal by the predetermined number (for example, 128, 256, or 512), converts each sampling signal into the digital amount by A/D conversion, and transmits it to the signal processing unit 107 to be described later. Accordingly, the echo signal is acquired as time-series digital data (hereinafter, referred to as echo data) including a predetermined number of sampling data.

The signal processing unit 107 performs various kinds of processing on the echo data and transmits the processed echo data to the measurement control unit 111.

The measurement control unit 111 is a control unit that transmits various commands for data collection, which is necessary for reconstruction of a tomographic image of the object 101, mainly to the gradient magnetic field power source 109, the RF transmission unit 110, and the signal detection unit 106 in order to control them. Specifically, the measurement control unit 111 operates under the control of the overall control unit 108 to be described later, and controls the gradient magnetic field power source 109, the RF transmission unit 110, and the signal detection unit 106 on the basis of a predetermined pulse sequence to repeatedly execute the application of an RF pulse and a gradient magnetic field pulse to the object 101 and the detection of an echo signal from the object 101 and collects the echo data necessary for reconstruction of an image in relation to an imaging region of the object 101.

The overall control unit 108 performs control of the measurement control unit 111 and control of various kinds of data processing and display, storage, and the like of the processing result, and is configured to include an arithmetic processing unit 114, which has a CPU and a memory, and a storage unit 115, such as an optical disc and a magnetic disk. Specifically, when the measurement control unit 111 is controlled to collect echo data and the echo data from the measurement control unit 111 is input, the arithmetic processing unit 114 stores the echo data in a region equivalent to the K space of the memory on the basis of the encoding information applied to the echo data. The echo data group stored in the region equivalent to the K space of the memory is also called K space data. In addition, the arithmetic processing unit 114 executes signal processing or processing, such as image reconstruction using a Fourier transform, on the K space data, and displays an image of the object 101, which is the result, on the display and operation unit 113, which will be described later, and also records it in the storage unit 115.

The display and operation unit 113 includes a display unit that displays the reconstructed image of the object 101 and an operating unit used to input various kinds of control information of the MRI apparatus or control information of processing performed by the overall control unit 108, such as a track ball, a mouse, and a keyboard. This operating unit is disposed close to the display unit, so that the operator controls various kinds of processing of the MRI apparatus interactively through the operating unit while observing the display unit.

In addition, the MRI apparatus related to the present invention includes a body motion information detection unit that detects body motion information of the object. The body motion information detection unit includes a sensor unit 116, which is attached to the object 101 in order to detect body motion information of the object, and a body motion information processor 117, which processes a signal from the sensor unit 116 and transmits the processed body motion information to the measurement control unit 111. If the body motion information detection unit detects an electrocardiogram (electrocardiographic waveform) of the object, the sensor unit 116 is an electrode which detects the electrocardiogram, and the body motion information processor 117 processes an analog signal from the electrode. The measurement control unit 111 controls synchronous imaging in which imaging by execution of a pulse sequence is performed in synchronization with the body motion information of the object detected by the body motion information detection unit.

In addition, in FIG. 1, the RF transmission coil 104 at the transmission side and the gradient magnetic field coil 103 are provided in the static magnetic field space of the static magnetic field generation magnet 102, in which the object 101 is inserted, such that they face the object 101 in the case of a vertical magnetic field method and they surround the object 101 in the case of a horizontal magnetic field method. In addition, the receiving RF coil 105 at the receiving side is provided so as to face or surround the object 101.

Nuclides imaged by current MRI apparatuses, which are widely used clinically, are a hydrogen nucleus (proton) which is a main constituent material of the object. The shapes or functions of the head, abdomen, limbs, and the like of the human body are imaged in a two-dimensional or three-dimensional manner by performing imaging of the spatial distribution of the proton density or the information regarding the spatial distribution of the relaxation time of the excited state.

(Regarding the Characteristics of the Measurement Trajectory of the Present Invention)

In the present invention, in a (k1-k2) space formed by k1 and k2 directions, which are directions perpendicular to a kr direction corresponding to the readout direction, in a three-dimensional K space (kr, k1, k2), echo data is measured along the measurement trajectories which are non-parallel (not perpendicular) to the coordinate axis (k1, k2) of the (k1, k2) space (hereinafter, such measurement is also called Non-Cartesian sampling). Measurement of the echo data along the measurement trajectories may be performed either at equal or unequal distances of the measurement trajectories. As a result, most data is echo data deviating from the grid points of the K space. In contrast, in the related art, echo data on the grid points of the K space is measured along the measurement trajectories which are parallel (perpendicular) to one of the coordinate axes of the K space (hereinafter, such measurement is also called Cartesian sampling).

As examples of the measurement trajectories non-parallel to the coordinate axis (k1, k2) of the (k1-k2) space, measurement trajectories obtained by rotating the basic measurement trajectory with the readout (kr) direction of the three-dimensional K space as its rotation axis may be considered. In other words, measurement trajectories obtained by rotating the basic measurement trajectory around the arbitrary reference point in the (k1-k2) space (for example, the origin, a point near the origin, or arbitrary points other than these) may be considered. Alternatively, it is also possible to measure the inside of the (k1-k2) space randomly.

As described above, in the present invention, Non-Cartesian sampling of the (k1-k2) space is performed. Therefore, since distinction between the phase encoding direction and the slice encoding direction in the conventional Cartesian sampling is completely eliminated, these two encoding directions cannot be distinctively defined. In the present invention, therefore, two directions perpendicular to the readout direction are set as the k1 and k2 directions, and a space spanned by these two directions is set as the (k1-k2) space. In the Cartesian sampling, it is normal practice for a person skilled in the art to write the phase encoding direction and the slice encoding direction in the three-dimensional K space as kp and ks directions, respectively, while clearly recognizing them. However, since the present invention is based on the Non-Cartesian sampling, there is no awareness of the phase encoding direction and the slice encoding direction. Since following the practice of those skilled in the art leads to misunderstanding, the present specification will disclose in a different manner.

In addition, each coordinate axis of the K space and the application direction of each gradient magnetic field in real space correspond to each other. That is, the application direction of the readout gradient magnetic field in real space corresponds to the readout direction in the K space, and the two directions perpendicular to the application direction of the readout gradient magnetic field in real space corresponds to two directions perpendicular to the readout direction in the K space. In the following explanation, on the basis of this correspondence, the directions are appropriately designated by the same expression without distinguishing the two coordinate spaces.

(Regarding the Characteristics of the Imaging Sequence of the Present Invention)

In the imaging sequence of the present invention, the amount of application of the encoding gradient magnetic field is controlled so as to perform Non-Cartesian sampling of the (k1-k2) space. Specifically, when a gradient magnetic field pulse is applied as a square wave, the application strength (G1, G2) of the encoding gradient magnetic field corresponding to the arbitrary measurement point (k1, k2) in the (k1-k2) space can be expressed by the following Expression (1).

G1=k1/(γ·FOV1·T)

G2=k2/(γ·FIV2·T) (1)

Here, T, FOV1, FOV2, and γ indicate application time of an encoding gradient magnetic field, a field-of-view size in the k1 direction, a field-of-view size in the k2 direction, and a gyromagnetic ratio, respectively. That is, in the present invention, when measuring the echo data of the arbitrary measurement point in the (k1-k2) space for Non-Cartesian sampling, an encoding gradient magnetic field which is determined by Expression (1) according to the coordinates of the measurement point is applied to measure the echo data.

As described above, in the present invention, since Non-Cartesian sampling of the (k1-k2) space is performed, the influence of T2 attenuation in the acquired echo data is distributed not only in the readout (kr) direction but also in the k1 and k2 directions. That is, the influence of T2 attenuation is distributed in a three-dimensional manner in the three-dimensional K space. As a result, it is possible to reduce the blurring of an MRA image obtained by Fourier transform. In the related art, since Cartesian sampling of the (k1-k2) space is performed, the influence of T2 attenuation concentrates in a specific direction. For this reason, there has been a problem in that an MRA image blurs in the direction. In the present invention, this problem is solved.

In addition, preferably, in the present invention, a dephase gradient magnetic field or a rephase gradient magnetic field is applied in at least the k1 and k2 directions in order to improve the quality of the MRA image. Preferably, the dephase gradient magnetic field or the rephase gradient magnetic field is applied in three directions including the kr direction. In this manner, it is possible to improve the ability to visualize blood vessels in the MRA image.

Moreover, preferably, in the present invention, the MRA image is acquired by performing synchronous imaging in which the imaging sequence for performing the above Non-Cartesian sampling is synchronized with body motion information of the object. Thus, although a plurality of cardiac beats are set as the imaging sequence repetition time (TR), this is to acquire a T2-weighted (T2W) image. Taking the T1 value of blood into consideration, in an object having a normal cardiac rate (around 60), it is preferable to set about two or three cardiac beats as a repetition time.

In addition, a delay time (DT) which is a time until the imaging sequence starts from synchronous timing (for example, an R wave of an electrocardiogram) or a time (that is, time to effective TE) from synchronous timing to the peak position of an echo signal designated by effective TE is controlled. Specifically, the delay time (DT) is set in systole in order to acquire a vein image. In addition, the delay time (DT) is set in diastole in order to acquire an arteriovenous image. Either electrocardiographic synchronization or pulse wave synchronization may be used as a synchronous method. Hereinafter, a plurality of embodiments regarding the Non-Cartesian sampling related to the present invention will be described with the time from the R wave to the effective TE as the delay time (DT) in an example of electrocardiographic synchronization.

### First Embodiment

Next, a first embodiment of the MRI apparatus and the blood vessel image capturing method of the present invention will be described. In the present embodiment, echo data is measured along a plurality of linear measurement trajectories obtained by rotating one linear trajectory with the readout (kr) direction in the three-dimensional K space as its rotation axis. That is, in the present embodiment, a linear measurement trajectory is set as a basic measurement trajectory, a measurement trajectory obtained by rotating the linear measurement trajectory with the readout (kr) direction in the (k1-k2) space as its rotation axis is used, and radial Non-Cartesian sampling is performed along such rotationally symmetric linear measurement trajectory. The imaging sequence related to the present embodiment measures echo data along these linear measurement trajectories. In this manner, since the influence of T2 attenuation in echo data can also be distributed in the two directions other than the readout direction, it is possible to suppress the blurring of blood vessels in the MRA image and accordingly to improve the ability to visualize blood vessels.

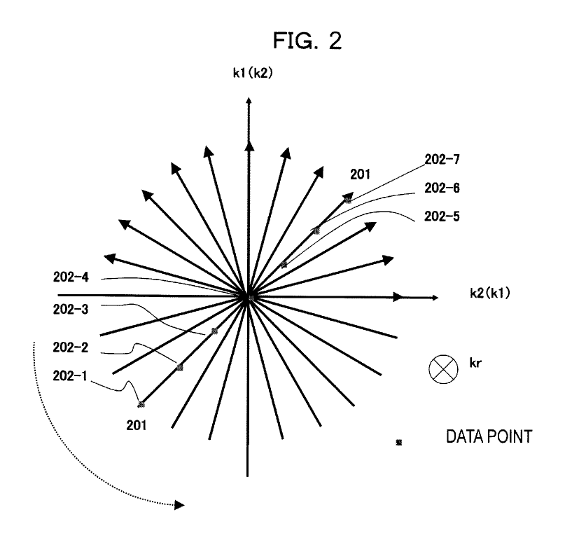

FIG. 2 is related to the present embodiment, and shows measurement trajectories for performing Non-Cartesian sampling of the (k1-k2) space. FIG. 2 shows only the (k1-k2) space, and the readout (kr) direction is a direction perpendicular to the (k1-k2) space and is also a direction perpendicular to the plane of the drawing. This is the same in subsequent explanation.

The measurement trajectories of the present embodiment are linear measurement trajectories passing through the origin of the (k1-k2) space or a point (arbitrary reference point) near the origin. Respective linear measurement trajectories are rotationally symmetric with respect to the readout (kr) direction as the rotation axis. Another linear measurement trajectory is obtained by rotating one arbitrary linear measurement trajectory by a predetermined angle around the origin in the (k1-k2) space or the point near the origin. In the case of rotation around the origin, the rotation axis is a readout axis. In the case of rotation around the arbitrary reference point, the rotation axis is a straight line parallel to the readout axis passing through the reference point. As another expression, in the present embodiment, each linear measurement trajectory is a measurement trajectory for performing radial sampling in the (k1-k2) space. In addition, echo data is measured at equal distances along each linear measurement trajectory. A plurality of echo data items along each linear measurement trajectory are measured within 1 repetition time (TR) of the imaging sequence or measured over a plurality of divided repetition time.

FIG. 2 is an example of rotating the linear measurement trajectory around the origin of the (k1-k2) space, and shows an example where echo data of seven measurement points (202-1 to 202-7) located at equal distances or at unequal distances is measured along a linear measurement trajectory 201 passing through the origin. This is the same for the measurement of echo data along other linear measurement trajectories.

In addition, in the present embodiment, measurement of echo data along the linear measurement trajectory passing through the origin of the (k1-k2) space described above is performed in synchronization with body motion information of the object. Specifically, a plurality of cardiac beats are set as the repetition time (TR) of the imaging sequence, and the rotation angle of a linear measurement trajectory is changed among a plurality of repetition time (TR). As a method of rotating the measurement trajectory, the measurement trajectory may be rotated by a predetermined angle every repetition time of the imaging sequence or may be rotated randomly. At the end of imaging, three-dimensional K space data necessary for image reconstruction is preferably acquired.

(Imaging Sequence Related to the First Embodiment)

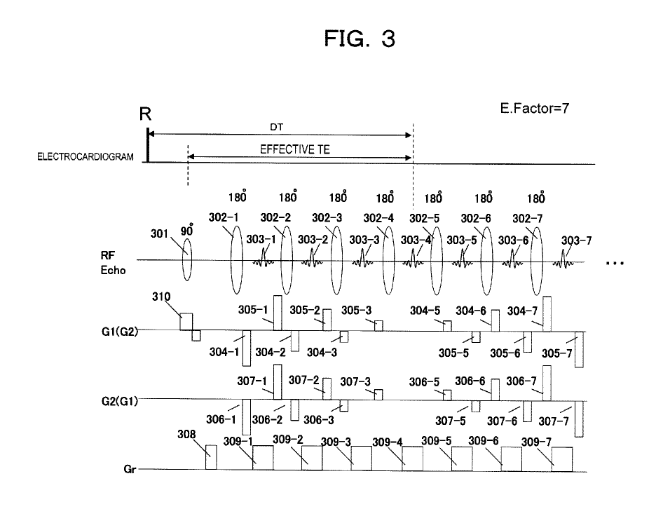

Next, the imaging sequence related to the present embodiment which is for measuring the echo data along the linear measurement trajectory passing through the origin of the (k1-k2) space shown in FIG. 2 will be described on the basis of FIG. 3. FIG. 3 is a sequence chart (timing chart) of the imaging sequence of the present embodiment, and shows an example of “echo factor=7”, that is, an example of measuring seven echo signals within 1 repetition time (TR) or by one excitation. ECG, RF/Echo, G1 (G2), G2 (G1), and Gr mean an electrocardiogram (electrocardiographic waveform), RF pulse/echo signal, a gradient magnetic field pulse waveform applied in the k1 (k2) direction, a gradient magnetic field waveform applied in the k2 (k1) direction, and a gradient magnetic field waveform applied in the readout direction, respectively. Hereinafter, this is the same in each sequence chart to be described later. In addition, since the k1 and k2 directions do not need to be distinguished in particular, the direction may be either the k1 direction or the k2 direction. Accordingly, they are described as a k1 (k2) direction and a k2 (k1) direction.

The measurement control unit 111 measures an echo signal by controlling the gradient magnetic field power source 109, the RF transmission unit 110, and the signal detection unit 106 on the basis of the sequence chart shown in FIG. 3. Specifically, a 90° RF pulse 301 is applied together with a slice selection gradient magnetic field 310 so that a desired imaging region (imaging region set in step 401 which will be described later) is excited. In addition, in FIG. 3, an electrocardiogram R wave is simply shown. Then, a 180° inversion RF pulse 302 is applied multiple times at predetermined intervals. Since the example of FIG. 3 is when echo factor=7, 180° inversion RF pulses (302-1 to 302-7) are applied seven times. In addition, an echo signal 303 is generated after the 180° inversion RE pulse 302, and seven echo signals (303-1 to 303-7) are measured. In this case, the delay time (DT) from an R wave in the electrocardiogram is a time from an R wave to the effective TE (that is, a time from an R wave to the peak position of the echo signal 303-4 disposed at the center of the K space). In addition, the 180° inversion RF pulse may be set as either slice selection or slice non-selection. By setting the slice non-selection, an improvement of the profile and an improvement of the ability to visualize blood vessels may be expected. FIG. 3 shows an example of slice non-selection. Sequence charts after FIG. 3 are also the same.

In order to make echo data on the straight line trajectory in the (k1-k2) space, encoding gradient magnetic fields 304 and 306 are applied to each echo signal 303 in the k1 and k2 directions. After the measurement of each echo signal 303, in order to return the phase of the transverse magnetization to the original zero by canceling the amounts of application of the applied encoding gradient magnetic fields 304 and 306, rewind gradient magnetic fields 305 and 307 each of which has an opposite polarity to the encoding gradient magnetic fields and has the amount of application (=area surrounded by the applied waveform and the time axis) with the same absolute value are applied in the k1 and k2 directions, respectively. The amounts of application of the encoding gradient magnetic fields 304 and 306 and the rewind gradient magnetic fields 305 and 307 are changed on the basis of Expression (1) according to the position of the measurement point in the (k1-k2) space. In the example shown in FIG. 3, the encoding gradient magnetic fields 304 and 306 are changed like “negative polarity and large amplitude->amplitude 0 (zero)->positive polarity and large amplitude” for each measurement of an echo signal, and the rewind gradient magnetic fields 305 and 307 are changed like “positive polarity and large amplitude->amplitude 0 (zero)->negative polarity and large amplitude” for each measurement of an echo signal. As a result, on one linear measurement trajectory 201 shown in FIG. 2, echo data of respective measurement points from one end to another end through the origin is measured. In the example shown in FIG. 2, echo data of seven measurement points 202-1 to 202-7 on the linear trajectory 201 is measured.

The amplitude ratio of the encoding gradient magnetic fields 304 and 306 in the k1 and k2 directions changes according to the rotation angle of the linear measurement trajectory in the (k1-k2) space. That is, an encoding gradient magnetic field with the maximum amplitude determined by the zero rotation angle is distributed to each of the encoding gradient magnetic fields in the k1 and k2 directions according to the rotation angle of the linear measurement trajectory. Accordingly, when changing and measuring the rotation angle of the linear measurement trajectory, the amount of application of the encoding gradient magnetic field distributed in the k1 and k2 directions is changed according to the rotation angle. That is, as shown in FIG. 3, by changing all amounts of encoding in the k1 and k2 directions given to each measured echo signal corresponding to the rotation angle, it is possible to perform a radial k space scan while rotating the linear measurement trajectory shown in FIG. 2 around the origin of the (k1-k2) space.

In addition, at the time of measurement of each echo signal 303, a readout gradient magnetic field 309 is applied, so that the spatial position information in the readout direction is encoded as each echo signal 303. Moreover, in order to measure each echo signal so that its peak is located in the approximate middle of the sampling time, a dephase gradient magnetic field 308 with the amount of application of the half of each readout gradient magnetic field 309 is applied before the readout gradient magnetic field 309 and after the slice selection gradient magnetic field 310.

The measurement control unit 111 repeats the above pulse sequence of 1 repetition time (TR) every plural cardiac beats. In this case, the rotation angle of a linear measurement trajectory is changed among a plurality of repetition time (TR). That is, as described above, the amounts of application of the encoding gradient magnetic field and the rewind gradient magnetic field are changed in order to change the rotation angle of the linear measurement trajectory. Preferably, the rotation angle of the linear measurement trajectory is changed every repetition time (TR). The rotation angle may be changed every predetermined fixed angle or may be changed randomly as described above. Alternatively, measurement of echo data along one linear measurement trajectory may be performed over a plurality of divided repetition time.

According to the imaging sequence of the present embodiment described above, the influence of T2 attenuation in the measured echo data can be distributed in a three-dimensional manner (at least in the k1 and k2 directions) by measuring the echo data radially in the (k1-k2) space perpendicular to the readout direction. As a result, it is possible to reduce the blurring of blood vessels in an MRA image obtained by Fourier transform.

(Reference Scan)

Moreover, in the present embodiment, an MRA image is acquired without administering the contrast medium to the object, that is, in a non-contrast manner using the above-described imaging sequence. Therefore, the measurement control unit 111 performs a reference scan to acquire the data for determining the values of imaging parameters which are suitable for acquisition of a desired non-contrast MRA image using the above-described imaging sequence. A reference scan is executed before the execution of the imaging sequence. The imaging sequence is executed on the basis of the appropriate imaging parameter values determined using the data acquired by this reference scan.

Imaging parameters having an influence on the quality of a non-contrast MRA image acquired by the imaging sequence include the delay time (DT) from an R wave for specifying the time phases of diastole and systole in a cardiac cycle and the blood flow speed in the blood vessel in an imaging region. Accordingly, imaging parameter values to be determined are values of the delay time (DT) and the blood flow speed.

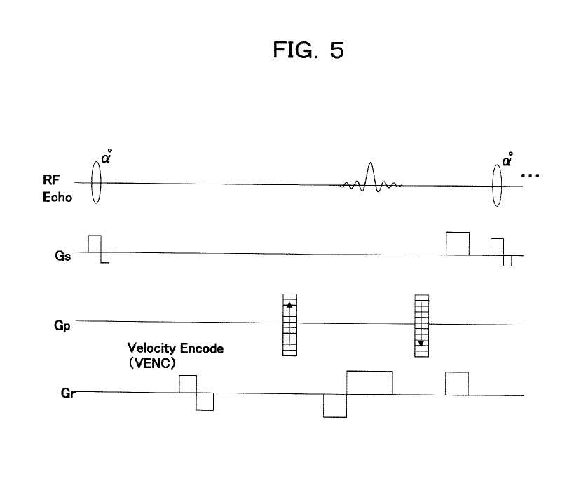

For example, when a PC (Phase Contrast) method pulse sequence shown in FIG. 5 is used as the reference scan, a desired imaging region (set in step 401 to be described later) is captured multiple times in time series, so that a plurality of phase images of the imaging region are acquired in time series. In addition, using the acquired time-series phase images, a temporal change in the phase of an observed blood flow portion is calculated to create a flow speed change graph of this blood flow. The relationship between the phase of a phase image and the blood flow speed can be calculated on the basis of the following Expression (2).

$$φ = \frac{1}{2} γ {Gvt}^{2} \qquad ( 2 )$$

Here, γ, G, v, and t are the Larmor frequency, a gradient magnetic field strength, a blood flow speed, and gradient magnetic field application time.

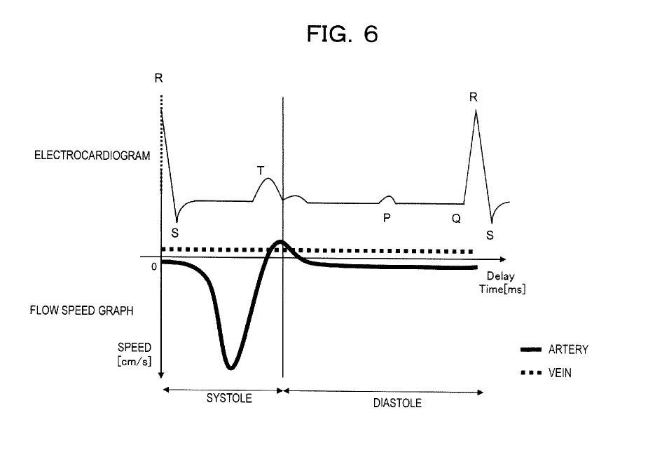

FIG. 6 shows an example of the blood flow change graph. This blood flow change graph is displayed in parallel at the same time scale as an electrocardiogram. The solid line is a flow speed change graph of the arterial blood flow, and the dotted line is a flow speed change graph of a vein. Accordingly, since the relationship between the electrocardiographic time phase and the blood flow speed is obvious, it is easy to set the delay time (DT) for specifying diastole or systole and the blood flow speed in the blood vessel in an imaging region. The setting is performed when the operator designates a desired point or period on this flow speed change graph through the display and operation unit 113, for example.

Generally, as shown in FIG. 6, reference numerals of P, Q, R, S, and T are given to the characteristic places of the electrocardiogram, an R-T period is systole and a T-R period is diastole. Therefore, if any part of the R-T period is set as a measurement period, a systole image (vein image) is acquired using echo data of the period. If any part of the T-R period is set as a measurement period, a diastole image (arteriovenous image) is acquired using echo data of the period.

In addition, when a reference scan is performed in a pulse sequence according to the main imaging sequence, the operator evaluates visually the ability to visualize the arteries and veins in the obtained image to determine the delay time (DT) and the blood flow speed and inputs and sets these values through the display and operation unit 113.

(Process Flow Related to the First Embodiment)

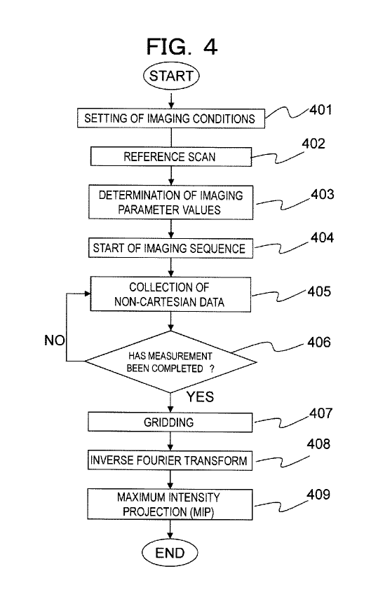

Next, a processing flow of the present embodiment for realizing the acquisition of a non-contrast MRA image using the imaging sequence of measuring the echo data along the measurement trajectory in the (k1-k2) space will be described on the basis of FIG. 4. FIG. 4 is a flow chart showing the process flow of the present embodiment. The overall flow of this operation flow and individual processing in each step are stored in advance as a program in the storage unit 115, such as a magnetic disk, and is executed when a CPU reads the program into the memory to execute it when necessary. Hereinafter, each step will be described in detail. In addition, since a non-contrast MRA image is acquired, there is no step of administering the contrast medium to the object.

In step 401, the operator sets the imaging conditions (an imaging region, FOV, readout direction, the number of matrices of an image, and the like) of the imaging sequence through the display and operation unit 113. In particular, for the setting of the readout direction, radially sampling of the (k1-k2) space is performed. Accordingly, since distinction between the phase encoding direction and the slice encoding direction is eliminated, only the readout direction is set. It is preferable to make the readout direction substantially match any one of H-F direction (Head-Foot), R-L (Right-Left) direction, and A-P (Anterior-Posterior) direction. In addition, it is desirable to match the readout direction to the traveling direction of a blood vessel. For example, when it is necessary to acquire a non-contrast MRA image of the leg, it is desirable to match the readout direction to the H-F direction since the traveling direction of the blood vessel of the leg is mainly the H-F direction.

In addition, the operator determines an arteriovenous image (diastole image) or a vein image (systole image) as the type of an MRA image to be acquired. On the basis of this determination, a method of image operation in a step to be described later is set.

In step 402, the measurement control unit 111 executes a reference scan in the imaging region set in step 401. Echo data or an image measured by the reference scan is used in order to determine the imaging parameter values, which are suitable for acquisition of a desired non-contrast MRA image using the above-described imaging sequence, in a step to be described later.

As a pulse sequence used for a reference scan, the pulse sequence based on the well-known PC method using velocity encoding (VENC) pulse as shown in FIG. 5 may be used as described above, or a pulse sequence according to the imaging sequence may be used. Details thereof are as described above.

In step 403, the arithmetic processing unit 114 determines the imaging parameter values, which are suitable for acquisition of a desired non-contrast MRA image using the imaging sequence, on the basis of the data (echo data or image data) measured by the reference scan in step 402. Imaging parameter values to be derived are as described above. In addition, the arithmetic processing unit 114 sets the above-described imaging sequence of FIG. 3 specifically on the basis of the imaging conditions set in step 401 and the imaging parameter values determined in step 403.

In step 404, using the imaging sequence set specifically in step 403, the measurement control unit 111 starts synchronous imaging (main imaging) by synchronizing the Non-Cartesian sampling of the present embodiment with the electrocardiogram detected from the object, for example.

In the synchronous imaging, the measurement control unit 111 sets two or more cardiac beats as the repetition time (TR) of the imaging sequence and changes the rotation angle of a linear measurement trajectory among the plurality of repetition time (TR). Accordingly, the application strength or the amount of application of the encoding gradient magnetic field according to the rotation angle of the linear measurement trajectory is changed for application.

In addition, on the basis of the MRA image type set in step 401 and the delay time (DT) determined in step 403, the measurement control unit 111 sets a delay time from an R wave. Specifically, the delay time (DT) from an R wave of the electrocardiogram is set in systole when acquiring a vein image, and the delay time (DT) from an electrocardiogram R wave is set in diastole when acquiring an arteriovenous image.

The measurement control unit 111 sets and starts the above-described imaging sequence for performing electrocardiographic synchronous Non-Cartesian sampling with a plurality of cardiac beats as the repetition time (TR).

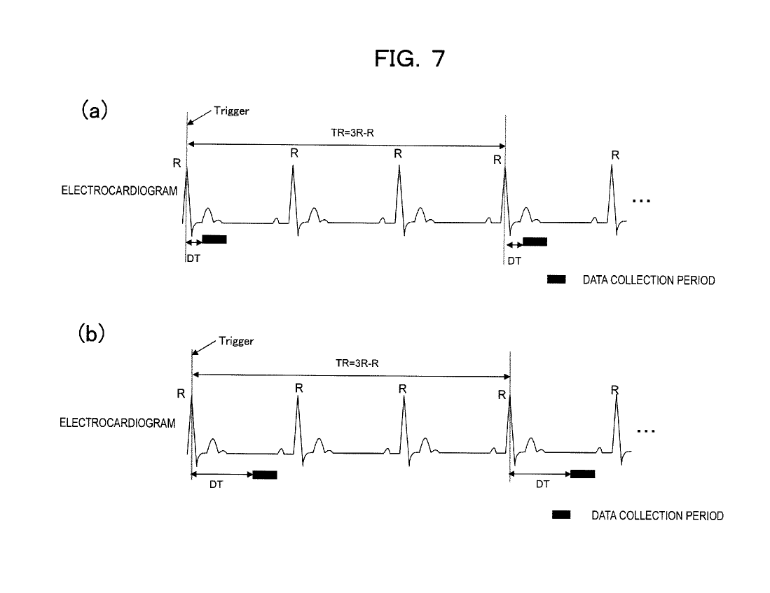

FIG. 7 is a synchronous imaging synchronized with an electrocardiogram, and shows a case of TR=3 cardiac beats (3R-R) as an example where a plurality of cardiac beats (R-R) are set as the repetition time (TR) of the imaging sequence. In addition, FIG. 7 shows an example where the imaging sequence is executed during a period of a black frame after the delay time (DT). FIG. 7(a) shows an example where the delay time (DT) is set in systole to acquire a vein image, and FIG. 7(b) shows an example where the delay time (DT) is set in diastole to acquire an arteriovenous image.

In step 405, the measurement control unit 111 measures echo data for acquiring a desired non-contrast MRA image by repeatedly executing the imaging sequence, which has been set and started in step 404 and which is for performing electrocardiographic synchronous Non-Cartesian sampling with a plurality of cardiac beats as the repetition time (TR). In this case, the measurement control unit 111 measures echo data along each linear measurement trajectory by controlling the output (application strength and the amount of application) of each encoding gradient magnetic field such that the linear measurement trajectory rotates in the (k1-k2) space with the readout (kr) direction in the three-dimensional K space as its rotation axis. Preferably, the measurement control unit 111 changes the rotation angle of each measurement trajectory every repetition time (TR). In addition, when measuring the echo data along each linear measurement trajectory, the measurement control unit 111 synchronizes the imaging sequence with an electrocardiogram R wave to perform such Non-Cartesian sampling after the delay time (DT) set in step 404.

In step 406, the measurement control unit 111 determines whether or not the measurement of the amount of echo data based on the imaging conditions set in step 401, that is, the amount of echo data necessary for image reconstruction has been completed. If the measurement has not yet been completed (No), the process returns to step 405 to continue the Non-Cartesian sampling of the present embodiment. In this case, the measurement control unit 111 changes the rotation angle of the linear measurement trajectory around the rotation axis to continue the measurement of echo data along the different linear measurement trajectory. If the measurement has been completed (Yes), the process proceeds to step 407.

In step 407, the arithmetic processing unit 114 relocates (gridding) the echo data measured in step 405 at each grid point of the three-dimensional K space. For example, the gridding processing is performed using a function for interpolation, such as a Sinc function or a Kaiser-Bessel function (NPL 1).

In step 408, the arithmetic processing unit 114 reconstructs a three-dimensional image by performing a Fourier transform of the three-dimensional K space data after the gridding in step 407. Then, according to the image type set in step 401, the arithmetic processing unit 114 performs various kinds of operations between the vein image (systole image) and the arteriovenous image (diastole image). For example, if the acquisition of an artery image is set in step 401, a difference operation is performed between the systole image and the diastole image, and a three-dimensional image acquired as a result of the difference operation is set as a three-dimensional artery image.

In step 409, the arithmetic processing unit 114 creates a projected image in a desired direction using the three-dimensional image data acquired as a result of the operation in step 408 and sets the projected image as a final non-contrast MRA image. As processing for creating the projected image, for example, a well-known MIP (Maximum Intensity Projection) method or volume rendering method may be used.

Until now, the process flow of the present embodiment has been described. In addition, without executing the reference scan, predetermined imaging parameter values or imaging parameter values determined in advance may be used. In this case, the imaging sequence is generated using these imaging parameter values determined in advance. Accordingly, it is not necessary to execute the above-described steps 402 and 403.

As described above, in the MRI apparatus and the blood vessel image capturing method of the present embodiment, the imaging sequence for measuring the echo data along a plurality of linear measurement trajectories having a readout direction in the three-dimensional K space as its rotation axis is executed in synchronization with the body motion information of the object. In this case, a plurality of cardiac beats are set as the repetition time (TR) of the imaging sequence, and the rotation angle of each linear measurement trajectory in the (k1-k2) space is changed among a plurality of repetition time (TR). Accordingly, since the influence of T2 attenuation in the measured echo data is distributed in a three-dimensional manner, it is possible to reduce the blurring of a non-contrast MRA image obtained by Fourier transform of the echo data measured in this manner. As a result, the image quality can be improved.

### Second Embodiment

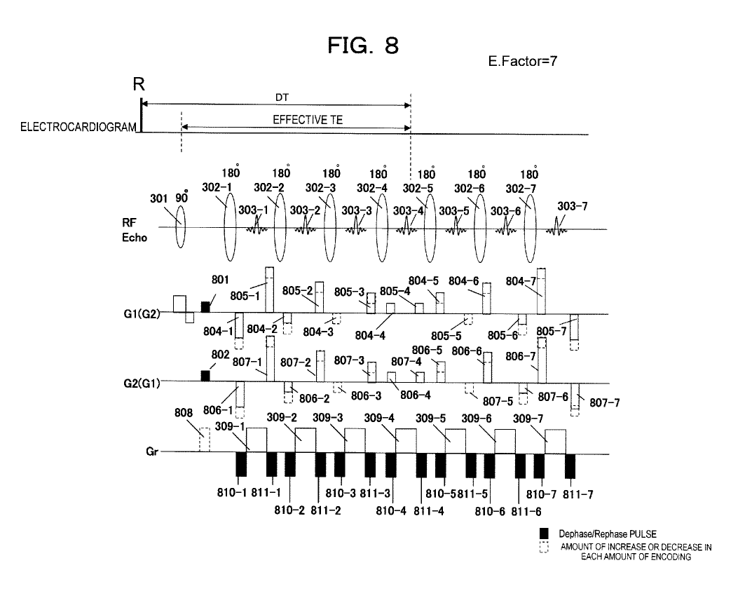

A second embodiment of the MRI apparatus and the blood vessel image capturing method of the present invention will be described. In the present embodiment, a rephase gradient magnetic field or a dephase gradient magnetic field for modulating the phase of the nuclear magnetization of a blood flow of the object is applied in each of directions in real space corresponding to two directions perpendicular to the readout direction in the three-dimensional K space. Specifically, in the imaging sequence of the first embodiment described above, the rephase gradient magnetic field or the dephase gradient magnetic field is applied in at least the k1 and k2 directions of the three axial directions. Preferably, the rephase gradient magnetic field or the dephase gradient magnetic field is applied in all directions including the readout (kr) direction. For example, assuming that the H-F direction is the readout direction, the rephase gradient magnetic field or the dephase gradient magnetic field is applied in the H-F direction, the R-L direction, and the A-P direction. In this manner, in the MRA image, is possible to improve the ability to visualize blood vessels that travel in the direction in which the rephase gradient magnetic field or the dephase gradient magnetic field is applied. Since others are the same as in the first embodiment described above, explanation thereof will be omitted. Hereinafter, the present embodiment is described in detail on the basis of FIG. 8.

FIG. 8 shows a sequence chart of the imaging sequence of the present embodiment. This is obtained by adding a dephase gradient magnetic field pulse or a rephase gradient magnetic field pulse to the imaging sequence shown in FIG. 3, which has been described in the above first embodiment, in the three directions.

Specifically, black rectangular gradient magnetic field pulses (801, 802, 810, 811) added to gradient magnetic fields in respective directions are equivalent to the dephase gradient magnetic field pulse or the rephase gradient magnetic field pulse (hereinafter, collectively called a phase control gradient magnetic field). Specifically, regarding the application direction of the readout gradient magnetic field (Gr), if the ratio of the amounts of application of the gradient magnetic field pulses 810, 309, and 811 is set to satisfy the relationship of approximately 1:2:1, the phase of the nuclear magnetization of a blood flow can be rephased. On the contrary, if the ratio of the amounts of application of the gradient magnetic field pulses 810, 309, and 811 is set to deviate from the relationship of approximately 1:2:1, the phase of the nuclear magnetization of a blood flow can be dephased. On the other hand, regarding the application directions of G1 (G2) and G2 (G2) gradient magnetic fields, the gradient magnetic field pulses 801 and 802 serve as dephase gradient magnetic field pulses and accordingly, the phase of the nuclear magnetization of a blood flow can be dephased. The measurement control unit 111 controls the application of a gradient magnetic field in each direction so as to execute the imaging sequence in FIG. 8.

As described above, in the encoding gradient magnetic field G1 (G2) in the k1 (k2) direction and the encoding gradient magnetic field G2 (G1) in the k2 (k1) direction, the phase control gradient magnetic fields 801 and 802 are applied, respectively, after a 90° pulse. However, the desired amount of encoding to be applied to an echo signal is influenced by these phase control gradient magnetic fields 801 and 802. Therefore, in the k1 (k2) direction and the k2 (k1) direction, the amounts of application obtained by adding or subtracting portions equivalent to the amounts of application of the phase control gradient magnetic fields 801 and 802 to or from the amounts of application of the original encoding gradient magnetic fields 304 and 306 and rewind gradient magnetic fields 305 and 307 are set for encoding gradient magnetic fields 804 and 606 and rewind gradient magnetic fields 805 and 807 of the present embodiment. A portion shown as a dotted frame in FIG. 8 is equivalent to the added or subtracted portion. Specifically, in the encoding gradient magnetic field G1 (G2), the encoding gradient magnetic field 804 obtained by subtracting a portion equivalent to the amount of application of the phase control gradient magnetic field 801 from the amount of application of the original encoding gradient magnetic field 304 is applied. In addition, the rewind gradient magnetic field 805 obtained by adding a portion equivalent to the amount of application of the phase control gradient magnetic field 801 to the amount of application of the original rewind gradient magnetic field 305 is applied. Similarly, in the encoding gradient magnetic field G2 (G1), the encoding gradient magnetic field 806 obtained by subtracting a portion equivalent to the amount of application of the phase control gradient magnetic field 802 from the amount of application of the original encoding gradient magnetic field 306 is applied. In addition, the rewind gradient magnetic field 807 obtained by adding a portion equivalent amount of application of the phase control gradient magnetic field 802 to the amount of application of the original rewind gradient magnetic field 307 is applied.

In addition, in the readout (kr) direction, the phase control gradient magnetic fields 810 and 811, which are applied when measuring an echo signal, are applied before and after the readout gradient magnetic field 309, respectively. In this case, since the amount of application of the dephase gradient magnetic field 308 to be originally applied is influenced, a dephase gradient magnetic field 808 obtained by subtracting the amount of application (portion shown as a dotted frame), which is equivalent to the amounts of application of the added phase control gradient magnetic fields 810 and 811, from the original dephase gradient magnetic field 308 is applied. In the example shown in FIG. 8, a case is shown in which the amount of application of the original dephase gradient magnetic field 308 and the subtracted portion are offset and accordingly, the amount of application of the dephase gradient magnetic field 808 is 0 (zero).

The above-described rephase gradient magnetic field or dephase gradient magnetic field for modulating the phase of the nuclear magnetization of the blood flow is applied in at least the k1 and k2 directions of the three axial directions. Preferably, the rephase gradient magnetic field or the dephase gradient magnetic field is applied in all directions including the readout (kr) direction. In this manner, it is possible to improve the ability to visualize blood vessels that travel in the direction in which the rephase gradient magnetic field pulse or the dephase gradient magnetic field pulse is applied. For example, when the H-F direction is set as the readout direction and the R-L direction and the A-P direction are set as the K1 and K2 directions, respectively, it is possible to improve the ability to visualize blood vessels, which travel in the R-L direction and the A-P direction, in a blood vessel image.

In addition, in the case of the radial Non-Cartesian sampling described in the above first embodiment, the amount of application of a dephase gradient magnetic field pulse or a rephase gradient magnetic field pulse may be changed according to the direction of the linear measurement trajectory on the k space. For example, only when the direction of the linear measurement trajectory matches the k1 or k2 direction, a dephase gradient magnetic field pulse or a rephase gradient magnetic field pulse may be applied.

Since performing the Non-Cartesian sampling of the (k1-k2) space or performing synchronous imaging in synchronization with the body motion information of the object using the imaging sequence of the above embodiment is the same as in the first embodiment described above, explanation thereof will be omitted. In addition, the present embodiment is suitable for acquisition of a non-contrast MRA image, and the effect of an improvement in the blood vessel visualization ability is noticeable in a non-contrast MRA image.

As described above, in the MRI apparatus and the blood vessel image capturing method of the present embodiment, the dephase gradient magnetic field pulse or the rephase gradient magnetic field pulse is applied in at least the k1 and k2 directions to acquire an MRA image. Therefore, in the MRA image, it is possible to improve the ability to visualize blood vessels that travel in the direction in which the dephase gradient magnetic field or the rephase gradient magnetic field is applied. In particular, when the H-F direction is set as the readout (kr) direction, the ability to visualize blood vessels that travel in directions (R-L direction and A-P direction), which are not the readout (kr) direction, can be improved in the MRA image. The effects of the present embodiment are especially noticeable in acquisition of a non-contrast MRA image.

### Third Embodiment

A third embodiment of the MRI apparatus and the blood vessel image capturing method of the present invention will be described. In the present embodiment, Non-Cartesian sampling is performed in order to measure the echo data along a plurality of unit trajectory groups obtained by rotating a unit trajectory group (blade), which is configured to include a plurality of parallel linear measurement trajectories, with the readout (kr) direction as its rotation axis. That is, in the present embodiment, a plurality of parallel linear measurement trajectories which form a blade are set as basic measurement trajectories, and the blade is set as measurement trajectories obtained by rotation around the arbitrary reference point in the (k1-k2) space. Accordingly, differences from the first embodiment described above are the imaging sequence and the shape of a measurement trajectory. Since others are the same as in the first embodiment described above, explanation thereof will be omitted. Hereinafter, the imaging sequence and the shape of a measurement trajectory of the present embodiment will be described in detail.

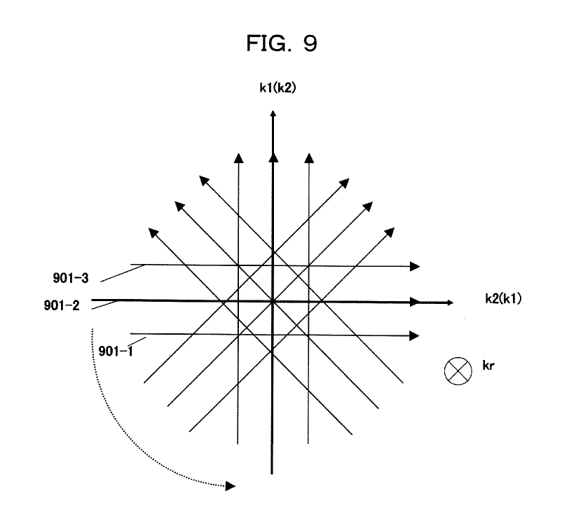

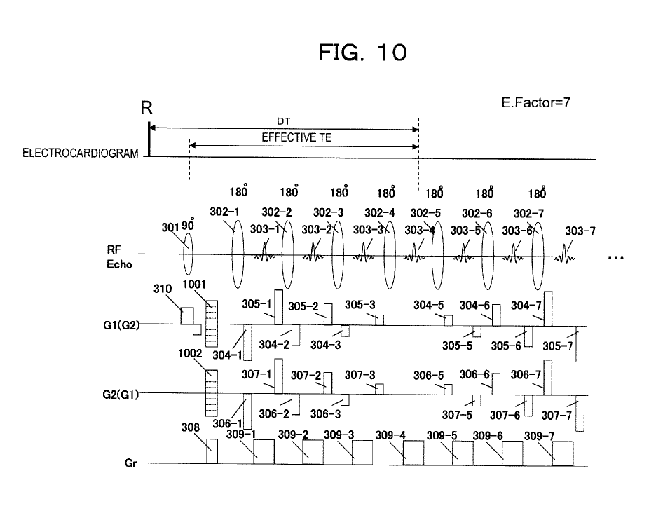

FIG. 9 shows an example of a Non-Cartesian measurement trajectory in the (k1-k2) space of the present embodiment, and FIG. 10 shows a sequence chart showing an imaging sequence for measuring the echo data along the measurement trajectory in FIG. 9. Hereinafter, such a pulse sequence is called a hybrid radial sequence.

Measurement trajectories in the (k1-k2) space shown in FIG. 9 are formed by rotating a blade, which is configured to include a plurality of parallel linear measurement trajectories, with the readout (kr) direction as its rotation axis, and echo data along a plurality of parallel linear measurement trajectories which form each blade after rotation is measured. In addition, although FIG. 9 shows an example where a blade has rotated around the origin of the (k1-k2) space, a point near the origin or the arbitrary reference point may also be set as the rotation center instead of the origin.

Specifically, a parallel linear measurement trajectory group configured to include one linear measurement trajectory shown in FIG. 2, which has been described in the first embodiment, and a plurality of linear measurement trajectories parallel to this is set as a blade. By rotating this blade in the (k1-k2) space with the readout (kr) direction as its rotation axis, a plurality of blades are generated. The number of linear measurement trajectories which form each blade, the number of blades, and the rotation angle can be determined such that a desired image is acquired. For example, the operator can set them in step 401 of FIG. 4. FIG. 9 shows an example where the number of parallel linear measurement trajectories which form a blade is 3 (901, 902, and 903). Echo data along the plurality of parallel linear measurement trajectories which form the blade is measured.

In addition, in the Non-Cartesian measurement trajectories of the present embodiment, gridding processing is required. Accordingly, the flow chart of the present embodiment is the same as FIG. 2 which is the flow chart of the first embodiment.

In the hybrid radial sequence shown in FIG. 10, in order to measure an echo signal along a plurality of parallel linear measurement trajectories in one blade, offset gradient magnetic fields 1001 and 1002 are respectively applied after a 90° RF pulse in the encoding gradient magnetic fields G1 (G2) and G2 (G1). The amount of application and the number of application steps of the offset gradient magnetic fields 1001 and 1002 differ according to the number of parallel linear measurement trajectories and a distance therebetween, and the offset gradient magnetic fields 1001 and 1002 can be determined according to Expression (3).

G=k/(γ·FOV·T) (3)

Here, k, T, FOV, and γ indicate a step number of an offset gradient magnetic field, application time of the offset gradient magnetic field, a field-of-view size in the application direction of the offset gradient magnetic field, and a gyromagnetic ratio, respectively.

The measurement control unit 111 applies the offset gradient magnetic fields 1001 and 1002, which are calculated every rotation angle by this Expression (3), when measuring the echo data along a plurality of parallel linear measurement trajectories which form a blade of the rotation angle. Other gradient magnetic fields are the same as those in the imaging sequence of FIG. 3 which has been described in the first embodiment. Accordingly, detailed explanation thereof will be omitted.

The above-described hybrid radial sequence is said to be robust against the body motion of an object, since the data near the reference point (in the case of FIG. 9, the origin) of rotation in the (k1-k2) space can be measured especially densely or in an overlapping state.

In addition, also in the hybrid radial sequence of the present embodiment, synchronous imaging described in the first embodiment or the application of the dephase gradient magnetic field and the rephase gradient magnetic field described in the second embodiment is performed in the same manner. Accordingly, explanation thereof will be omitted. In addition, if these are combined to acquire a non-contrast MRA image, the same effects as in the first embodiment can be obtained.

As described above, in the MRI apparatus and the blood vessel image capturing method of the present embodiment, Non-Cartesian sampling is performed in order to measure an echo signal along a plurality of parallel linear measurement trajectories obtained by rotating a blade, which is configured to include a plurality of parallel linear measurement trajectories, with the readout (kr) direction as its rotation axis. As a result, the same effects as in the first embodiment described above can be obtained. In addition, since such measurement trajectories are used, it is possible to acquire an MRA image which is robust against the body motion of an object.

### Fourth Embodiment

Next, a fourth embodiment of the MRI apparatus and the blood vessel image capturing method of the present invention will be described. In the present embodiment, a measurement trajectory formed by connecting two line segment trajectories to each other at the origin of the (k1-k2) space or the point near the origin (hereinafter, referred to as a polygonal measurement trajectory) is used, and Non-Cartesian sampling is performed in order to measure the echo data along a plurality of polygonal measurement trajectories with different angles between two line segments. That is, in the present embodiment, the polygonal measurement trajectory is set as a unit measurement trajectory, and measurement trajectories obtained by rotating the polygonal measurement trajectory around the arbitrary reference point in the (k1-k2) space while changing the bending angle are used. Accordingly, differences from the first embodiment described above are the imaging sequence and the shape of a measurement trajectory. Since others are the same as in the first embodiment described above, detailed explanation thereof will be omitted. Hereinafter, the imaging sequence and the shape of a measurement trajectory of the present embodiment will be described in detail.

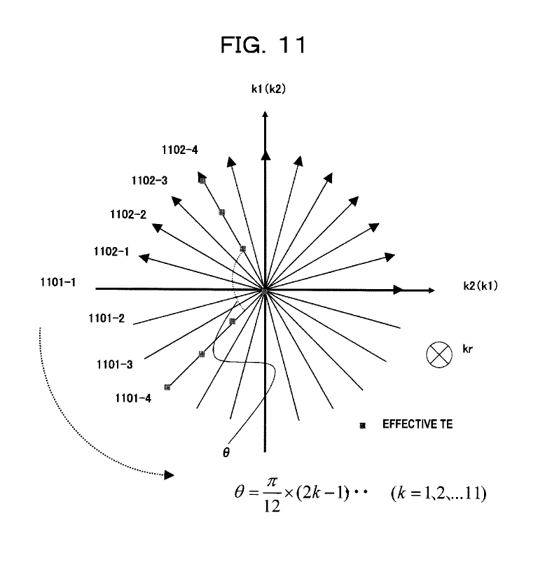

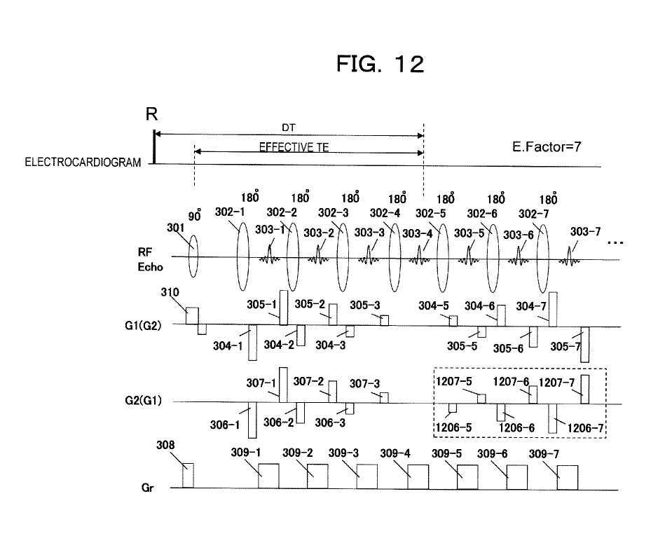

FIG. 11 shows an example of a polygonal measurement trajectory in the (k1-k2) space of the present embodiment, and FIG. 12 shows a sequence chart showing an imaging sequence for measuring the echo data along the polygonal measurement trajectory in FIG. 11.

One arbitrary measurement trajectory in the (k1-k2) space shown in FIG. 11 bends by the angle θ at the origin of the (k1-k2) space or the point near the origin. As a result, it becomes a polygonal measurement trajectory formed by connection of two line segments at the origin or the point near the origin. That is, this is a polygonal measurement trajectory formed when a line segment trajectory extending from the end (high frequency side) of the (k1-k2) space toward the center (low frequency) and a line segment trajectory extending from the center (low frequency) toward another end (high frequency side) of the (k1-k2) space are connected to each other at the origin or the point near the origin so as to form the angle θ. In addition, the (k1-k2) space is filled with a plurality of polygonal measurement trajectories which have the same connection point and different angles between two line segments. Assuming that the number of polygonal measurement trajectories is k, the relationship between k and the bending angle θ can be expressed by Expression (4), for example.

θ=(π/12)×(2k−1) (k=1,2,3, . . . ,11) (4)

Assuming that the first half of a measurement trajectory when k=1 is a line segment trajectory 1101-1 in FIG. 11, the bending angle θ between the line segment trajectory 1101-1 and a line segment trajectory 1102-1 of the second half is θ=π/12. Similarly, assuming that the first half of a measurement trajectory when k=2 is a line segment trajectory 1101-2 in FIG. 11, the bending angle θ between the line segment trajectory 1101-2 and a line segment trajectory 1102-2 of the second half is θ=π/4. Similarly hereinbelow, as a line segment trajectory 1101 of the first half of the measurement trajectory is selected sequentially counterclockwise, a line segment trajectory 1102 of the second half of each measurement trajectory will be clockwise. In this case, the angle between these two line segment trajectories increases gradually. Therefore, the (k1-k2) space can be filled with these all polygonal measurement trajectories. FIG. 11 and Expression (4) show an example where the (k1-k2) space is filled with eleven polygonal trajectories. In addition, although all polygonal measurement trajectories shown in FIG. 11 bend at the origin of the (k1-k2) space, bending points of the plurality of polygonal measurement trajectories may be set differently.

Echo data on the first-half line segment and the second-half line segment of such a polygonal measurement trajectory is not in the relationship of complex conjugates to each other with respect to the origin of the (k1-k2) space. In general, echo data which is in the relationship of complex conjugates to each other with respect to the origin of the k space has substantially the same amount of information. That is, an echo data group along the polygonal measurement trajectory in the present embodiment has a larger amount of information than the echo data group along the linear measurement trajectory in the first embodiment. Accordingly, the polygonal measurement trajectory of the present embodiment is suitable for asymmetric measurement and reconstruction of the K space since a large amount of information can be acquired in a short time. When performing asymmetric measurement and reconstruction using the bent measurement trajectory of the present embodiment, it is preferable to change the bending points of a plurality of polygonal measurement trajectories to acquire symmetrically the low-frequency echo data near the origin of the (k1-k2) space.

In addition, in the Non-Cartesian measurement trajectories of the present embodiment, gridding processing required. Accordingly, the flow chart of the present embodiment is the same as FIG. 2 which is the flow chart of the first embodiment.

The imaging sequence shown in FIG. 12, which is for measuring the echo data along the above measurement trajectories, is different from the imaging sequence shown in FIG. 3 described in the first embodiment in that the polarities and amplitudes of an encoding gradient magnetic field pulse 1206 and a rewind gradient magnetic field pulse 1207 in a dotted frame portion are different. The reason is as follows. The above-described imaging sequence shown in FIG. 3 is for measuring the echo data along the linear measurement trajectory. Accordingly, when the measurement trajectory is a straight line extending from the third quadrant of the (k1-k2) space to the first quadrant, the amplitudes of the encoding gradient magnetic field and the rewind gradient magnetic field also increase or decrease monotonically. On the other hand, the imaging sequence shown in FIG. 12 is for measuring the echo data along the polygonal measurement trajectory. Accordingly, when measuring the echo data along the first half of the polygonal measurement trajectory, the amplitudes of the encoding gradient magnetic field pulse and the rewind gradient magnetic field pulse also increase or decrease monotonically in the same manner as in the imaging sequence shown in FIG. 3. However, at the time of measurement of the echo data along the second half of the polygonal measurement trajectory, the measurement trajectory bends. Accordingly, the encoding gradient magnetic field 1206 and the rewind gradient magnetic field 1207 do not increase or decrease monotonically subsequent to the first half, but the increase or decrease pattern is reversed. That is, when attention is paid to a dotted frame portion of the sequence chart in FIG. 12, the amplitude of the encoding gradient magnetic field pulse 1206 decreases monotonically with negative polarity in FIG. 12, while the amplitude of the encoding gradient magnetic field pulse increases monotonically with positive polarity in FIG. 3. The amplitude changes corresponding to the bending angle of the polygonal line. In addition, the rewind gradient magnetic field pulse 1207 changes so as to have the opposite polarity to the encoding gradient magnetic field pulse 1206. By such changes of the encoding gradient magnetic field and the rewind gradient magnetic field, measurement of the echo data along the polygonal trajectory is possible.

In addition, also in the imaging sequence of the present embodiment, synchronous imaging described in the first embodiment or the application of the dephase gradient magnetic field and the rephase gradient magnetic field described in the second embodiment is performed to acquire an MRA image in the same manner. Accordingly, detailed explanation thereof will be omitted. In addition, if these are combined to acquire a non-contrast MRA image, the same effects as in the first embodiment can be obtained.

As described above, in the MRI apparatus and the blood vessel image capturing method of the present embodiment, Non-Cartesian sampling is performed in order to measure the echo data along the polygonal measurement trajectory which bends at the origin in the (k1-k2) space or the point near the origin and in which the angle formed by the polygonal lines differs according to each measurement trajectory. Therefore, the same effects as in the first embodiment described above can be obtained. In addition, since the polygonal measurement trajectory is used, it is possible to obtain the effect that a large amount of information can be acquired in a short time.

### Fifth Embodiment

Next, a fifth embodiment of the MRI apparatus and the blood vessel image capturing method of the present invention will be described. In the present embodiment, a spiral measurement trajectory passing through the origin of the (k1-k2) space or the point near the origin is used. In addition, Non-Cartesian sampling is performed in order to measure the echo data along a plurality of spiral trajectories obtained by rotating one spiral trajectory with the readout (kr) direction as its rotation axis. That is, in the present embodiment, a spiral measurement trajectory is set as a unit measurement trajectory, and measurement trajectories are obtained by rotating the spiral measurement trajectory around the origin of the (k1-k2) space or the point near the origin. Accordingly, differences from the first embodiment described above are the imaging sequence and the shape of a measurement trajectory. Since others are the same as in the first embodiment described above, explanation thereof will be omitted. Hereinafter, the imaging sequence and the shape of a measurement trajectory of the present embodiment will be described in detail.

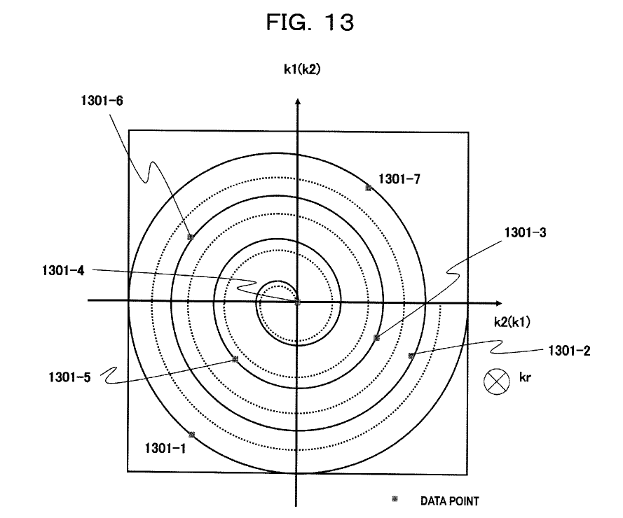

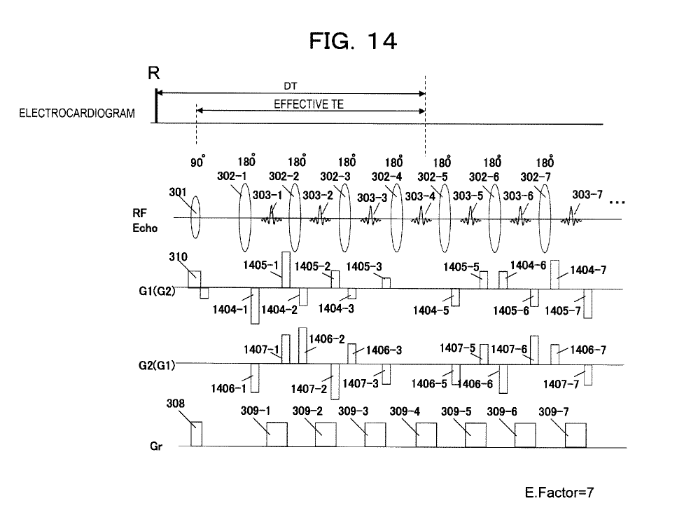

FIG. 13 shows an example of a spiral measurement trajectory in the (k1-k2) space of the present embodiment, and FIG. 14 shows a sequence chart showing an imaging sequence for measuring the echo data along the spiral measurement trajectory in FIG. 13.

One arbitrary measurement trajectory in the (k1-k2) space shown in FIG. 13 is a spiral trajectory passing through the origin of the (k1-k2) space or the point near the origin. In addition, a plurality of spiral measurement trajectories are acquired by rotating one spiral measurement trajectory by predetermined angles with the readout (kr) direction as its rotation axis. FIG. 13 shows a spiral measurement trajectory indicated by the solid line and a dotted spiral measurement trajectory obtained by rotating the spiral measurement trajectory around the origin. The number of rotations of each spiral measurement trajectory around the origin or the point near the origin may be arbitrarily set, and it is possible to use a measurement trajectory which rotates once or less around the origin of the (k1-k2) space or use a measurement trajectory which rotates multiple times around the origin of the (k1-k2) space.

Echo data on these spiral measurement trajectories may be measured sequentially from the center (low frequency) toward the end (high frequency) or conversely, from the end (high frequency) toward the center (low frequency), or movement may be performed randomly on the spiral measurement trajectory to measure the echo data. FIG. 13 shows an example where the echo data is measured in order of 1301-1 to 1301-7, that is, in order moving from the end side of one spiral trajectory toward the center and then returning from the center on the same trajectory toward the end side.

In the case of such a spiral measurement trajectory, the (k1-k2) space can be scanned approximately uniformly by one measurement trajectory. Accordingly, since the influence of T2 attenuation in the measured echo data or the influence of body motion can be distributed in a three-dimensional manner, it is possible to reduce the influence of blurring or body motion artifacts in the MRA image. As a result, the image quality can be improved.

In addition, in the Non-Cartesian measurement trajectories of the present embodiment, gridding processing is required. Accordingly, the flow chart of the present embodiment is the same as FIG. 2 which is the flow chart of the first embodiment.

The imaging sequence shown in FIG. 14, which is for measuring the echo data along the above spiral measurement trajectory, has different encoding gradient magnetic fields G1 (G2) and G2 (G1), compared with the imaging sequence shown in FIG. 3 described in the first embodiment. In the case of the encoding gradient magnetic fields G1 (G2) and G2 (G1) in the imaging sequence shown in FIG. 3, the amplitude or the amount of application of each encoding gradient magnetic field pulse increases or decreases monotonically in order to measure the echo data along the linear measurement trajectory. In contrast, the encoding gradient magnetic fields G1 (G2) and G2 (G1) of the present embodiment are waveforms applied in order to measure the echo data along the spiral measurement trajectory. Accordingly, the encoding gradient magnetic fields G1 (G2) and G2 (G1) of the present embodiment change complicatedly on the basis of the above-described Expression (1). For example, echo data of the measurement points 1301-1 to 1301-7 on the spiral measurement trajectory shown in FIG. 13 corresponds to the echo signals 303-1 to 303-7 in the sequence chart shown in FIG. 14, respectively. Accordingly, encoding gradient magnetic field pulses 1404 and 1406 and rewind gradient magnetic field pulses 1405 and 1407 which are applied to measure the echo signals 303-1 to 303-7 areas shown in FIG. 14. In addition, since details of the spiral measurement trajectory is disclosed in PTL 3, for example, detailed explanation thereof will be omitted.

In addition, also in the imaging sequence of the present embodiment, synchronous imaging described in the first embodiment or the application of the dephase gradient magnetic field and the rephase gradient magnetic field described in the second embodiment is performed to acquire an MRA image in the same manner. Accordingly, detailed explanation thereof will be omitted. In addition, if these are combined to acquire a non-contrast MRA image, the same effects as in the first embodiment can be obtained.

As described above, in the MRI apparatus and the blood vessel image capturing method of the present embodiment, Non-Cartesian sampling is performed in order to measure the echo data along the spiral measurement trajectory passing through the origin or the point near the origin in the (k1-k2) space. Therefore, the same effects as in the first embodiment described above can be obtained. In addition, since the spiral measurement trajectory is used, it is possible to reduce the influence of blurring or body motion artifacts in the MRA image. As a result, the image quality can be improved.

### Sixth Embodiment

Next, a sixth embodiment of the MRI apparatus and the blood vessel image capturing method of the present invention will be described. In the present embodiment, a measurement trajectory passing through a plurality of grid points zigzag or randomly in two directions perpendicular to the readout direction in a three-dimensional K space is used. That is, in the present embodiment, Non-Cartesian sampling is performed in order to measure the echo data along the measurement trajectory passing through a plurality of grid points zigzag or randomly in the (k1-k2) space. Accordingly, differences from the first embodiment described above are the imaging sequence, the shape of a measurement trajectory, and that gridding is unnecessary. Since others are the same as in the first embodiment described above, explanation thereof will be omitted. Hereinafter, the imaging sequence and the shape of a measurement trajectory of the present embodiment will be described in detail.

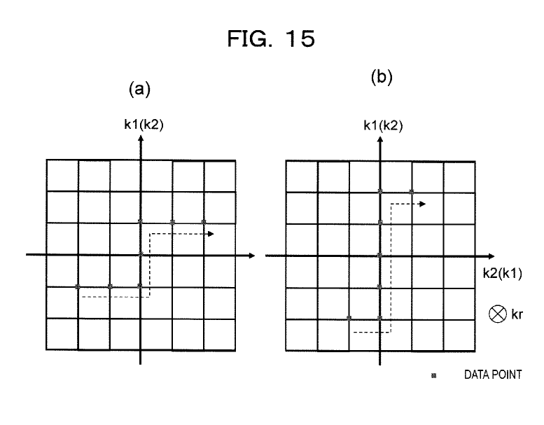

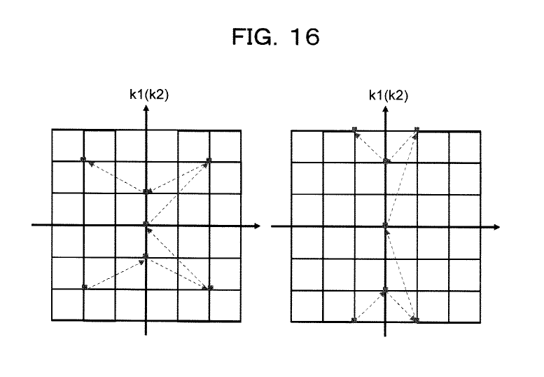

FIGS. 15 and 16 show examples of the measurement trajectory for measuring the echo data while moving the grid points of the (k1-k2) space zigzag or randomly in the present embodiment.

The measurement trajectory shown in FIG. 15 is an example of one basic zigzag measurement trajectory for performing Non-Cartesian zigzag sampling of the echo data of the grid point of the (k1-k2) space. Echo data of the nearest grid point is measured while rotating the basic zigzag measurement trajectory by the predetermined angle around the origin or the arbitrary reference point. Preferably, echo data of the nearest grid point is measured while rotating the basic zigzag measurement trajectory by the predetermined angle every repetition time (TR) of the imaging sequence. FIG. 15(a) is an example of the basic zigzag measurement trajectory with a small width in the k1 (k2) direction, and shows an example of measuring the echo data of each grid point in the dotted arrow direction of the drawing. FIG. 15(b) shows an example of the basic zigzag measurement trajectory having a larger width in the k1 (k2) direction than the basic zigzag measurement trajectory in FIG. 15(a). Rotating the measurement trajectory in the (k1-k2) space is the same as in FIG. 15(a). Alternatively, it is also possible to measure the echo data of the nearest grid point to each Non-Cartesian measurement trajectory described in the first to fourth embodiments.

FIG. 16 is an example where Non-Cartesian sampling of echo data of the grid point of the (k1-k2) space is performed randomly, and shows an example of measuring the echo data of each grid point in order of the dotted arrow. In order to measure the echo data of each grid point randomly, the measurement control unit 111 generates a pseudo-random number to determine the grid point, and determines the amounts of application of the encoding gradient magnetic fields G1 and G2 of the imaging sequence according to the determined grid point position on the basis of Expression (1). In addition, the measurement control unit 111 changes the position of the grid point to be measured every repetition time of the imaging sequence. Preferably, the positions of the measurement grid points are changed every repetition time so as not to overlap each other. In addition, preferably, the application of the encoding gradient magnetic field is controlled such that the echo data of the effective TE necessarily becomes K space center data.

As described above, the imaging sequence related to the present embodiment, which is for measuring the echo data while moving the grid point of the (k1-k2) space zigzag or randomly, has different encoding gradient magnetic fields G1 (G2) and G2 (G1), compared with the imaging sequence shown in FIG. 3 described in the first embodiment. Specifically, it is preferable to set the amplitude or the amount of application of each of the encoding gradient magnetic field pulse and the rewind gradient magnetic field pulse every grid point, which is measured zigzag or randomly, according to the coordinate value of the grid point on the basis of Expression (1). As a result, the amplitude or the amount of application of each of the encoding gradient magnetic field pulse and the rewind gradient magnetic field pulse becomes irregular. Detailed illustration and explanation thereof will be omitted.

In addition, also in the imaging sequence of the present embodiment, synchronous imaging described in the first embodiment or the application of the dephase gradient magnetic field and the rephase gradient magnetic field described in the second embodiment is performed to acquire an MRA image in the same manner. Accordingly, detailed explanation thereof will be omitted. In addition, if these are combined to acquire a non-contrast MRA image, the same effects as in the first embodiment can be obtained.

As described above, since the echo data of the grid point position of the K space is measured in both the zigzag and random cases, it is not necessary to perform gridding processing at the time of image reconstruction. For this reason, the arithmetic processing unit 115 skips the gridding processing of step 407 in the process flow shown in FIG. 4 described in the first embodiment, and performs a Fourier transform of the K space data measured in step 408.

As described above, in the MRI apparatus and the blood vessel image capturing method of the present embodiment, Non-Cartesian sampling is performed in order to measure an echo signal along the measurement trajectory, in which the echo data of the grid point is zigzag or random, in the (k1-k2) space. Therefore, the same effects as in the first embodiment described above can be obtained. In addition, since the echo data of the grid point is directly measured, gridding processing is not necessary. In the present embodiment which does not need the gridding processing, therefore, it is possible to simplify the image reconstruction processing and perform the image reconstruction processing in a short time.

The above is specific embodiments to which the present invention is applied. However, the present invention is not limited to the content disclosed in each of the embodiments described above, and various embodiments based on the spirit of the present invention may be adopted. For example, it is possible to perform Non-Cartesian sampling by combining the measurement trajectories described in the respective embodiments. What is necessary is to set a Non-Cartesian measurement trajectory such that the influence of T2 attenuation in the measured echo data is distributed in a three-dimensional manner.

In addition, in explanations of each embodiment of the present invention, an example of acquiring a non-contrast MRA image without administering the contrast medium to the object has been described. However, also when acquiring a contrast MRA image by administering the contrast medium, the image quality can be improved by applying each embodiment of the present invention.

### REFERENCE SIGNS LIST

101: object
102: static magnetic field generation magnet
103: gradient magnetic field coil
104: transmission RF coil
105: receiving RF coil
106: signal detection unit 106
107: signal processing unit
108: overall control unit
109: gradient magnetic field power source
110: RF transmission unit
111: measurement control unit
112: bed
113: display and operation unit
114: arithmetic processing unit
116: storage unit
117: sensor unit
117: body motion information processor

1. A magnetic resonance imaging apparatus comprising:
a body motion information detection unit that detects body motion information regarding periodic body motion of an object;
a measurement control unit that controls measurement of three-dimensional K space data by executing synchronous imaging synchronized with the periodic body motion information on the basis of an imaging sequence; and
an arithmetic processing unit that reconstructs a blood vessel image of the object using the three-dimensional K space data,
wherein the imaging sequence is for measuring echo data along measurement trajectories non-parallel to two directions perpendicular to a readout direction in the three-dimensional K space, and
the measurement control unit controls the synchronous imaging such that a repetition time (TR) of the imaging sequence becomes a plurality of periods of the body motion information.

2. The magnetic resonance imaging apparatus according to claim 1,
wherein the measurement trajectories are a plurality of linear measurement trajectories obtained by rotating one linear trajectory with the readout direction of the three-dimensional K space as a rotation axis, and
the measurement control unit repeats the imaging sequence to measure echo data along different linear trajectories.

3. The magnetic resonance imaging apparatus according to claim 1,
wherein the periodic body motion information is an electrocardiogram,
the synchronous imaging is an imaging synchronized with an R wave of the electrocardiogram, and
the measurement control unit starts the imaging sequence after predetermined delay time (DT) from the R wave.

4. The magnetic resonance imaging apparatus according to claim 3,
wherein the delay time is a time for execution of the imaging sequence in diastole or systole.

5. The magnetic resonance imaging apparatus according to claim 1,
wherein the arithmetic processing unit determines imaging parameter values, on the basis of data acquired by imaging the object in advance by a reference scan, so that a desired image can be acquired using the imaging sequence and sets the imaging sequence on the basis of the determined imaging parameter values, and
the measurement control unit executes the set imaging sequence.

6. The magnetic resonance imaging apparatus according to claim 5,
wherein the imaging parameter values include a delay time (DT) from an electrocardiogram R wave for execution of the imaging sequence in diastole or systole in the electrocardiogram of the object.

7. The magnetic resonance imaging apparatus according to claim 5,
wherein the measurement control unit performs the reference scan using a PC method pulse sequence, and
the arithmetic processing unit acquires flow speed change information of an observed blood flow portion on the basis of data acquired by the reference scan.

8. The magnetic resonance imaging apparatus according to claim 7, further comprising:
a display unit that displays the flow speed change information as a blood flow change graph; and
an input unit that receives an input to set the delay time (DT) on the flow speed change graph displayed on the display unit.

9. The magnetic resonance imaging apparatus according to claim 1,
wherein, in the imaging sequence, a rephase gradient magnetic field or a dephase gradient magnetic field for modulating a phase of nuclear magnetization of a blood flow of the object is applied in each of directions in real space corresponding to two directions perpendicular to the readout direction in the three-dimensional K space.

10. The magnetic resonance imaging apparatus according to claim 1,
wherein the measurement trajectories are a plurality of unit trajectory groups obtained by rotating a unit trajectory group, which is configured to include a plurality of parallel linear measurement trajectories, with the readout direction of the three-dimensional K space as a rotation axis.

11. The magnetic resonance imaging apparatus according to claim 1,
wherein the measurement trajectories are polygonal measurement trajectories, each of which is formed by connecting two line segment trajectories to each other, and are a plurality of polygonal trajectories h different angles between the two line segment trajectories.

12. The magnetic resonance imaging apparatus according to claim 1,
wherein each of the measurement trajectories is a spiral measurement trajectory.

13. The magnetic resonance imaging apparatus according to claim 1,
wherein each of the measurement trajectories is a measurement trajectory passing through a plurality of grid points zigzag or randomly in two directions perpendicular to the readout direction in the three-dimensional K space.

14. A blood vessel image capturing method comprising:
a measurement step of measuring echo data along measurement trajectories in a three-dimensional K space by synchronous imaging in which an imaging sequence is synchronized with an electrocardiogram of an object; and
a step of acquiring a blood vessel image of the object using the measured echo data,
wherein the measurement trajectories are measurement trajectories non-parallel to two directions perpendicular to a readout direction in the three-dimensional K space, and
a repetition time (TR) of the imaging sequence is a plurality of periods of the electrocardiogram.

15. The blood vessel image capturing method according to claim 14,
wherein the measurement trajectories are a plurality of linear measurement trajectories obtained by rotating one linear trajectory with the readout direction of the three-dimensional K space as a rotation axis, and
in the measurement step, the imaging sequence is repeated to measure echo data along different linear trajectories.

16. The blood vessel image capturing method according to claim 14,
wherein, in the imaging sequence, a rephase gradient magnetic field or a dephase gradient magnetic field for modulating a phase of nuclear magnetization of a blood flow of the object is applied in each of directions in real space corresponding to two directions perpendicular to the readout direction in the three-dimensional K space.

17. The blood vessel image capturing method according to claim 14, further comprising:
a step of acquiring data by imaging the object in advance by a reference scan;
a step of determining imaging parameter values for acquiring the blood vessel image using the imaging sequence on the basis of the data acquired by the reference scan; and
a step of setting the imaging sequence on the basis of the determined imaging parameter values.
